(19) United States
(12) Patent Application Publication
(10) Pub. No.: US 2026/0318785 A1
(43) Pub. Date: Oct. 15, 2026

(54) SYSTEMS AND METHODS FOR DRONE-BASED LASER VIBROMETRY FOR MACHINE HEALTH MONITORING AND FAULT DIAGNOSIS

(71) Applicant: KCF TECHNOLOGIES, INC., State College, PA (US)

(72) Inventor: Jacob LOVERICH, State College, PA (US)

(73) Assignee: KCF TECHNOLOGIES, INC., State College, PA (US)

(21) Appl. No.: 19/175,883

(22) Filed: Apr. 10, 2025

(51) Int. Cl. G01M 99/00; G01H 9/00

(52) U.S. Cl. CPC G01M 99/005; G01H 9/00

(57) ABSTRACT

Systems, methods and computer-readable medium monitor a health condition of a machine with a drone having a laser vibrometer device. The laser vibrometer device is configured to take vibration measurements of the machine from an aerial position. A computerized device receives signals based on the vibration measurements of the machine, the signals being representative of: 1) a vibration of the drone; and 2) a vibration of the machine plus a vibration of the drone. The computerized device is configured to determine a vibration of the machine by compensating the vibration of the machine plus the vibration of the drone with the vibration of the drone. The vibration of the machine is used by the computerized device to determine a health condition of the machine.

### TECHNICAL FIELD

This disclosure relates to systems and methods for collecting data for machine health monitoring and fault diagnosis. More particularly, this disclosure relates to such systems and methods for enabling drones to perform predictive maintenance health monitoring of industrial assets.

### BACKGROUND

Machine health monitoring in industrial manufacturing plants is based on analyzing vibration signatures collected by sensors that are mounted on machines. This technique that has been employed to predict and diagnose machine failures for decades. The machines that are monitored are generally large industrial 10-1000 Hp motors, pumps, fans, gearboxes, etc. Conventional technology used to measure vibration have either required a sensor permanently mounted and hardwired into a data acquisition unit or a portable/handheld device, like the Emerson AMS2140, and a magnetically mounted sensor that is moved from machine to machine. The permanent hardwired sensor approach is expensive because cabling needs to be installed and is vulnerable to damage which drives the solution lifecycle cost. The portable sampling approach is also problematic because it generally involves a reliability engineer walking from machine to machine which is labor intensive and often dangerous because a person is working round running equipment.

Drones have the potential to offer a much more cost effective, safer, and more flexible way to measure machine health. Drones already are commercially used for monitoring industrial assets like fluid levels in tanks, temperature profiles on critical assets, pipe thickness, damage to electrical power lines, corrosion, and many more applications. These measurements are taken with instruments like cameras, lasers for static distance measurement, and microphones.

Drone monitoring may cost $90-102/hr for a piloted drone. An autonomous drone may cost $25-37/hr including maintenance, amortized capital cost, and charging [https://levitatecap.com/levitate/wp-content/uploads/2020/12/White-Paper-v4.pdf]. Considering that it takes roughly 1 minute to acquire a vibration data set and fly to a new location in a typical manufacturing plant, the cost per measurement could range between $0.41 and $1.70 per measurement point. In contrast, the cost to perform a vibration measurement monthly using a route vibration measurement is roughly $30-40 per measurement point.

The benefits of drone vibration monitoring are not just lower cost but also greater flexibility. Monitoring schedules for different assets can be accelerated based on health status. For example, as a machine becomes less healthy, more frequent health checks could automatically be scheduled. Other benefits include, monitoring extremely hot assets which can't be done with accelerometers that are typically limited to 120 C. Whereas a vibrometer could measure up to hundreds of degrees. Finally, many assets are located in difficult to reach locations (high up like on a digester tower or far away like in a tank farm). Drones also mitigate safety risk associated with workers performing monitoring near dangerous machines. Its worth noting that most injuries in manufacturing plants occur during unplanned maintenance which is often performed at night or on weekends.

However, drone machine health monitoring is unique compared to other drone monitoring and it poses more challenging requirements because high frequency vibration signatures are needed and the measurement tool (laser vibrometer in this case) must be very stable during a measurement. The high frequency vibration signatures contain the key information for diagnosing faults. For high frequency drone vibration monitoring to be practical, the measurement needs to be done remotely without physical contact with the machines. Non-contact vibration measurement technology called laser Doppler vibrometry has long been used for modal analysis of complex structures and is generally done in a highly controlled lab environment.

Doppler-based vibrometry requires a clean and reflective target on the asset and a relatively short distance to the target. Doppler vibrometers are expensive, large, heavy, and power hungry. This has made them impractical for drone vibration monitoring and is the primary reason drones have not been used for vibration monitoring.

Recent advances in vibrometry enable a simpler lower cost and more robust solution. Rather than using the Doppler effect, these new vibrometers use conventional lasers and signal processing borrowed from the fiber optic communication industry. Measurements may be based on differences in the time of flight of the laser beam rather than the Doppler effect. These new laser vibrometers weigh less than a pound and are the size of a typical drone camera.

However, one major challenge still limits drone vibration monitoring: drone vibration and drift while a reading is being taken. Both contribute more to the relative vibration measurement taken from a drone laser vibrometer than the actual vibration of the asset alone. Compensation of the drone point-to-point distance from the drone laser vibrometer to the target is needed in addition to compensation for changes in distance due to dynamic orientation changes of the laser relative to the target.

An analogous topic is camera stabilization, which for drones, dates to the very first modern flights in the 1970 s-1980 s. Such approaches have improved dramatically and are now commonly used on most drones, even small ones. However, techniques for camera stabilization are not relevant for laser vibrometer measurement because they require several orders of magnitude lower levels of stabilization, operate at much lower frequencies of around 30-60 Hz, and often have the advantage of using a fields of pixel values (whole image) rather than a single point measurement.

For example, most modern drone camera stabilization focuses on passive vibration absorption complimented by image processing techniques that use Kalman filtering or other methods for essentially removing drone movement from a series of images.

### SUMMARY

Disclosed herein are systems, methods, and computer-readable medium for drone based laser vibrometry for machine health diagnosis. In some embodiments, the system may include a drone, and a laser vibrometer device mounted on the drone. The laser vibrometer device is configured to take vibration measurements of the machine from an aerial position. A computerized device receives signals based on the vibration measurements of the machine, the signals being representative of: 1) a vibration of the drone; and 2) a vibration of the machine plus a vibration of the drone. The computerized device is configured to determine a vibration of the machine by compensating the vibration of the machine plus the vibration of the drone with the vibration of the drone.

The vibration of the machine is used by the computerized device to determine a health condition of the machine.

### BRIEF DESCRIPTION OF THE DRAWINGS

Generally like reference numerals in the various figures are utilized to designate like components.

FIG. 1 illustrates an industrial plant where a drone flies along a route from asset to asset measuring the health of industrial machines.

FIG. 2 shows a drone-mounted laser vibrometer measuring the vibration of targets on industrial machines.

FIG. 3 illustrates an example vibration spectrum recorded by the laser vibrometer and its presentation in a cloud-based machine health monitoring software.

FIG. 4 illustrates drone vibration which introduces error in laser vibrometer measurements taken by the drone.

FIG. 5 illustrates a drone measuring a fixed target with one laser vibrometer and a target mounted on the vibrating asset with a second laser vibrometer.

FIG. 6 illustrates a flowchart of steps taken by the system illustrated in FIG. 5.

FIG. 7 illustrates a drone measuring a fixed target with a laser vibrometer to create a baseline reading of the drone vibration before then moving to a second location to measure the vibrating asset.

FIG. 8 illustrates a flowchart of steps taken by the system illustrated in FIG. 7.

FIG. 9 illustrates a drone measuring a vibrating asset using a laser vibrometer and a gyroscope and accelerometer for measuring the vibration of the drone vibrometer.

FIG. 10 illustrates a flowchart of steps taken by the system illustrated in FIG. 7.

FIG. 11 shows a triaxial accelerometer and gyroscope mounted on a vibrometer to enable compensate for vibration of the drone and vibrometer.

FIG. 12 shows a 2D error compensation model for the embodiment where the accelerometer and gyroscope are used to compute the change in laser beam length as a result of vibrometer vibration.

FIG. 13 shows three vibration time series from a blower aerator in a concrete plant where the first includes error due to the drone and aerator, the second only error due to the drone, and finally the vibration of the aerator alone.

FIG. 14 shows three vibration spectrum from a blower aerator in a concrete plant where the first includes error due to the drone and aerator, the second only error due to the drone, and finally the vibration of the aerator alone.

FIG. 15 shows a computerized system for carrying out the methods described in accordance with various embodiments.

### DETAILED DESCRIPTION

This invention defines a new way to monitor the health of machines in industrial manufacturing plants like automotive stamping plants, pulp and paper mills, steel mills, mines, or food and beverage manufacturing plants. In these plants machine health and failure potential is measured based on minuet changes in the mechanical motion (vibration) of machines that occur periodically and at high frequency to determine degradation in a component or multiple components. Because much of the information needed for health assessment is at very high vibration frequency, data is acquired in short duration snap shots to minimize the total data collected and analyzed. Data is collected in blocks so that operations like a Fourier transform can be applied and frequency spectrum analysis conducted. For example, a monitoring system may acquire vibration data at 4 kHz for a period of 1 second. The data block in this case is 4000 equally spaced data points taken over a 1 second period.

The compensation used in embodiments disclosed herein utilizes a drone that targets micro motion and at high frequencies which is required for machine health analysis and failure diagnosis. Embodiments disclosed herein make vibration measurements that are accurate at frequencies up to 10 kHz with precision on an order of micro inches for accurate machine vibration diagnostics with a drone. These differences from conventional practices utilize a novel approach to compensation for such micro motions which are not used by conventional systems and methods.

Prior art related to drone stabilization or movement compensation have been designed around supporting video or image capture, laser distance measurement used for navigation, or 3D scans used for capturing models of objects. Such drone camera stabilization used passive vibration absorption complimented by image processing techniques that use Kalman filtering or other methods for essentially removing drone movement from a series of images. Whereas the laser vibrometer compensation used by embodiments herein measures the high frequency micro movement of the drone and applies correction to a unidirectional measurement based on that movement.

Various embodiments disclosed herein may use four steps to achieving accurate drone-based laser vibration monitoring: 1) measure the vibration of the drone laser vibrometer caused by the drone operation or environmental conditions, 2) translate that vibration into an expected vibration along the laser beam relative to an expected known asset target, 3) measure the actual vibration of an asset target using the drone-mounted laser vibrometer, wherein the measurement includes both the vibration of the drone and the asset target, 4) and take the difference between the expected vibration due to the drone alone and the vibration of the asset target measured by the drone-mounted vibrometer. Additional steps include a guided route that the drone takes when moving between predetermined locations in an industrial plant and wirelessly sending vibration data sets to a gateway located in the plant. The data error correction may also be computed onboard the drone and the resulting accurate asset data sent over the wireless link or downloaded off of the drone.

This set of steps may be used when a drone flies from location to location taking measurements at stops along a predetermined route. Targets or essentially flat reflective plates are located on the assets such as pumps, motors, fans, or gearboxes in locations where the asset is to be measured (e.g., bearing housing). The target can simply be a location on an asset that is flat, relatively smooth, and reflective. An example is the name plate on a motor. The target doesn't need to be a dedicated object affixed to the machine. A drone laser vibrometer measures the high frequency movement of the target relative to the vibrometer.

In most cases, the drone will not land and is instead in a relatively fixed hover while a laser vibrometer measurement is taken. Therefore, the actual raw measurements include the small vibration movement of the drone and the asset target. Because the target is often not perpendicular to the laser, the raw measurement includes error due to the rotational vibration of the laser relative to the target. This error can be large and dominate the total error if the drone is far from the target.

The drone location relative to a target measurement point is known apriority based on the absolute (GPS or other RTLS reading) drone stop location and the absolute known and fixed location of the asset target to be measured. This relative position of the drone to the target is important in the error compensation especially for cases where drone rotational vibration dominates the error.

The drone uses one of two different methods to measure the drone-induced vibration of the vibrometer instrument. The first uses the vibrometer itself to measure a fixed target. The signal can be used directly to compensate for the error in the measurement of the vibrating asset. A second approach uses triaxial accelerometers and gyroscopes to measure the movement of the laser vibrometer. Knowing high frequency movement of the drone, the distance to the target, and the orientation of the target, the error or change in distance owing to the drone movement (vibration) from the laser vibrometer to the point on the target where the laser is shining can be calculated. This calculation can then be used to offset the laser vibrometer reading which results in an output corresponding only to the vibration of the asset target (along the path of the laser).

These calculations may be typically completed on the drone and the compensated vibration data may be wirelessly sent from the drone to a gateway in plant and then to the cloud or locally hosted databases where the data can be analyzed. Alternatively, the data may be sent directly from the drone to a cloud server over a cellular or satellite communication link. The analysis includes reviewing the vibration signatures for faults associated with the mechanical or electrical degradation in the assets the drone measures. These measurements are trended over time and changes in the asset health status are used to schedule maintenance early and avoid unexpected asset failure that causes costly plant downtime and loss of production.

Embodiments disclosed herein use a laser vibrometer that collects data based on changes in a concentrated beam of light directed at the surface of an object. The laser measures only the unidirectional motion in the direction of the laser beam. The laser can generally be located between 1-30 feet from the asset that is being measured. The laser measurement may be configured with a low sensitivity to the beam angle relative to the surface and how reflective it is, but a perpendicular orientation and highly reflective surface are preferred. Because of the mobile nature of the vibrometer it can be mounted on a drone and moved from point to point.

In various embodiments, the laser vibrometer may be mounted to a drone that may be configured to fly from asset to asset making stops along the way to collect vibration data blocks. At each stop a vibrometer reading is taken at predetermined locations on assets that may be designated by targets. The drone may be configured to fly the route several times per day, weekly, or monthly depending on the type of plant or status of the assets. In various embodiments, the route can be adapted based on the status of the assets. For example, some assets may need to be measured more frequently if they are critical or are deemed to be at risk of failure. The risk assessment can be based on the readings from the laser vibrometer or other data sources.

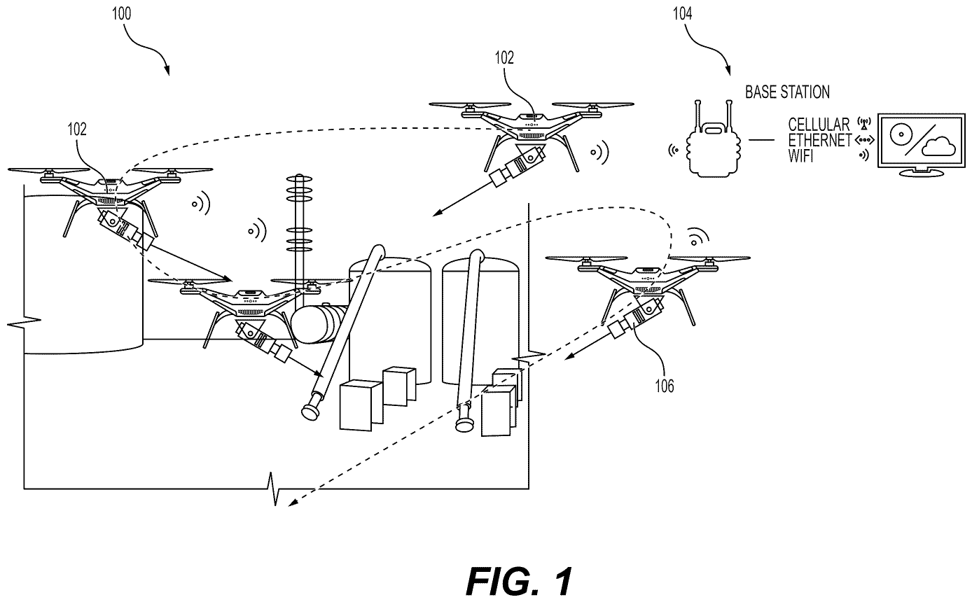

FIG. 1 Illustrates a typical environment 100 where the drone laser vibrometry may be deployed. The drone 102 can store the readings while completing a route or send the data to a base station or gateway devices 104 located in a plant or other location. The gateway 104 may be configured to send data over ethernet, WiFi, cellular, satellite or other industrial communication means to a local server or cloud server where the data may be stored, processed and served to a user interface. Similarly, if the drone 102 is storing data over the course of the route traveled by the drone, in some embodiments, the data may be downloaded after the flight and then uploaded to a cloud hosted data repository or other memory.

In some embodiments, an inspection class drone may be used because the laser vibrometer 106 may be configured to weigh less than a pound and the route may have around 100 stops. In some situations, this may take around two hours considering the launch, landing, and travel time to the assets from an office. In a large plant, there may be up to a dozen different routes that are taken over the course of a week while smaller plants may only have a single route.

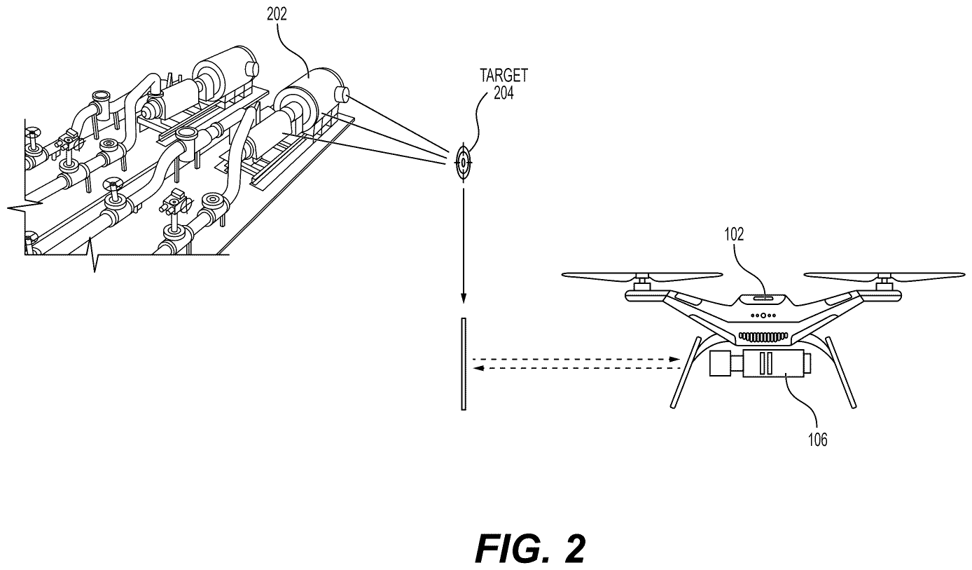

FIG. 2 shows a typical asset or machine 202 that the drone vibrometer 106 is configured to measure. In this example, the asset 202 is a water pump, but other assets may be used. The pump may have several locations where vibration measurements are to be taken such as a motor inboard bearing, a motor outboard bearing, and fluid end (pump) inboard bearings. Since the actual bearings of the pump may not be exposed, the exterior housing of the pump may be measured. Various embodiments may be configured to take measurements in both the vertical and horizontal directions. In many cases the drone may be configured to hover in one location and steer or direct the laser to measure several points sequentially but in other cases, where the asset is larger, the drone may be configured to move around the asset 202 to gain the best access to the targeted monitoring locations.

The asset 202 may typically have a target 204 mounted to the machine at the monitoring locations. The targets 204 may be rigid metal plates that are bolted or adhesively mounted to the asset 202. The targets may be typically 1-3″ square and have a reflective surface. The laser vibrometer 106 works well even on dirty surfaces but clean reflective surfaces increase the precision and consistency of the measurement.

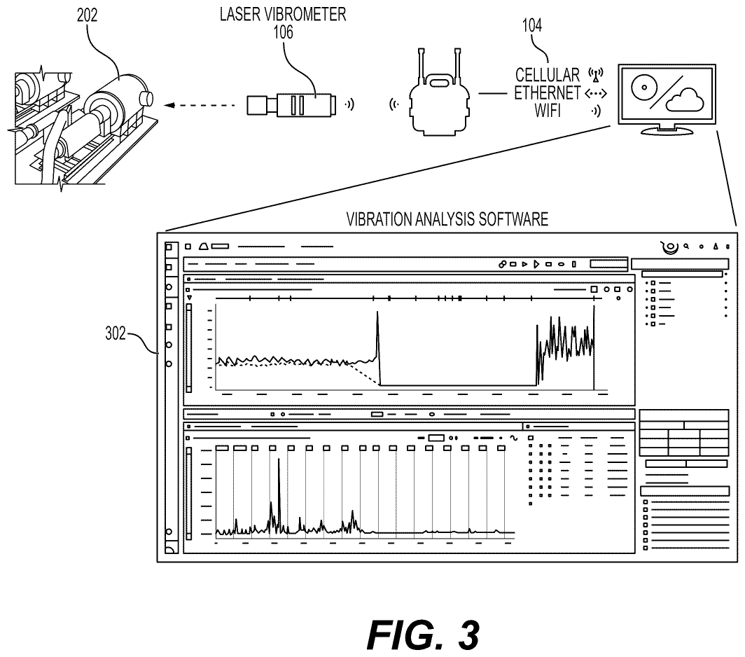

FIG. 3 shows the laser vibrometer 106 transferring data to a gateway 104 or other computerized device which in some embodiments then relays the data to a cloud server where it is analyzed and presented in a software interface 302. Although this embodiment uses a cloud server to analyze the data, any computerized device may be used to analyze the data, such as a laptop or desktop computer, a cell phone, a tablet device, etc. Alternatively, the data may be analyzed and/or presented in the gateway 104 or other computerized device, which may include a display for presenting the results. The data may be machine health data used to determine health conditions of machines or assets being monitored and/or to recommend repairs or other maintenance on the machines or assets. In some embodiments, the data may be analyzed in the drone such as determination of the vibration of the machine and health conditions of the machine. The data can be transferred wirelessly or through a wired connection. The gateway 104 can do preprocessing of the data to reduce the data size and optimize the data transfer speed which is useful in many remote locations where ethernet and cellular connectivity is limited. For example, the data can be compressed, or fault features can be extracted and sent to the cloud instead of the large raw data files.

In some embodiments, the software may use AI to automatically determine the fault status of an asset and provide recommendations for repair when repair is determined to be needed. Often the recommendations for repair are based on a vibration frequency spectrum which may also be shown in the software. For example, a bearing failure may have characteristic fault frequencies that correspond to the rolling elements in the bearing rolling over a crack in one of the races. The impact of the rolling element each time the shaft rotates occurs at a frequency which is a multiple of the shaft speed. The repeated impacting appears in the frequency spectrum as a peak.

Recommendations, based on the vibration data, may include replacing or lubricating a bearing and/or other repairs. In some embodiments, the recommendations can automatically trigger a work order or work request in maintenance planning software like IBM Maximo. The work request may contain instructions or a job plan based on the recommendations for repair, service, or inspection.

The machine health data is often used for more than just scheduling maintenance and/or repairs. It can be used to adapt the manufacturing process around a pending failure, slow down a process to ease load on the equipment, or avoid a running condition that creates unnecessary load. To enable the relationship between process and machine health to be established and leveraged in plant operations, the machine health data is shared to a data lake or data historian where it can be combined or displayed alongside operational or process data.

These practices are common in industrial plants, however drones are not used for vibration measurement today. They are only currently used for laser scanning to build 3D models, security inspections, fixed asset health (corrosion, erosion, etc.), and process monitoring like checking tank levels or raw material status. Drone vibration measurement has not been possible because drones vibrate themselves and separating the drone vibration from the vibration of the asset it is measuring has not been effectively achieved.

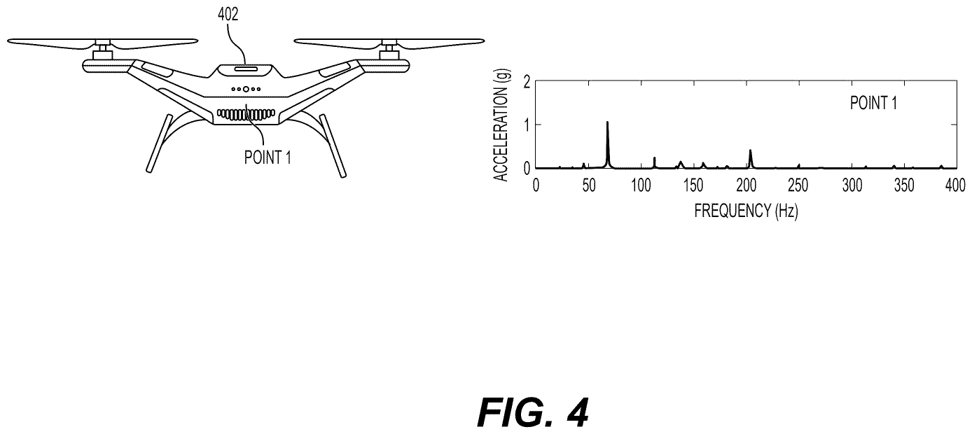

FIG. 4 shows vibration of a drone 402, which in some embodiments may be an industrial inspection class drone. The drone vibration is mainly caused by mechanical imbalances or miss alignment in the drive train of the drone. Other contributions to drone vibration include aerodynamic load variation due to the blades passing by the fuselage or other components of the drone. A typical drone vibration spectrum is shown in the figure.

The vibration is concentrated in the 50-250 Hz range which unfortunately is the key frequency range where many faults are observed in industrial equipment. For example, most industrial assets run at 20, 30, or 60 Hz in North America depending on the number of poles of the motor. Fault frequencies are typically a multiple of the running speed. Imbalances are observed at 1X, misalignment at 2X and 3X, and bearing frequencies a range between 5X-20X. These fault frequencies clearly overlap with the drones 50-250 Hz range where the drone vibration is problematic.

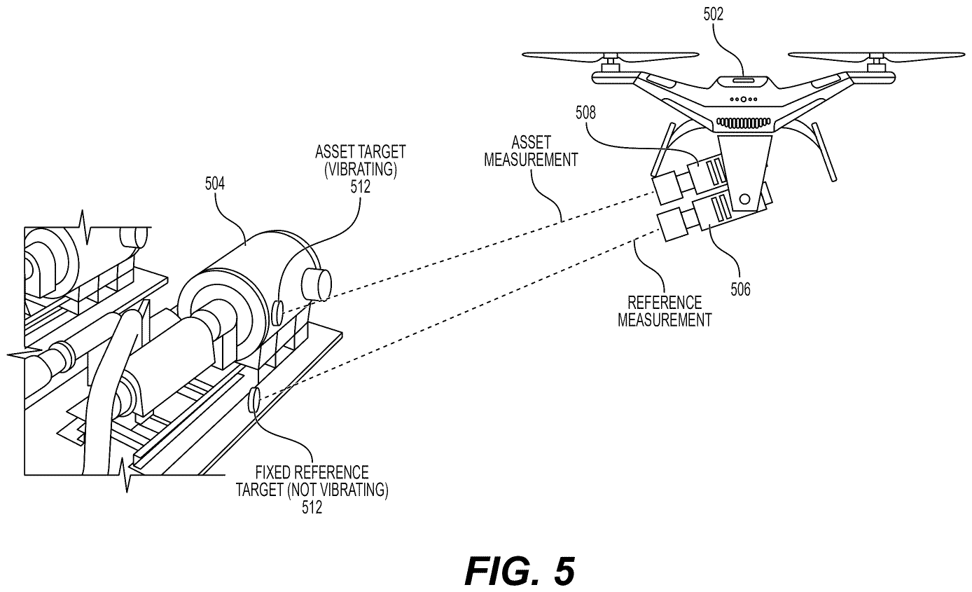

FIG. 5 shows a laser vibrometer that is used for drone machine health monitoring. In this first embodiment two laser vibrometers 506, 508 are rigidly mounted to one another via a gimble which is attached to a drone 502. One vibrometer 508 is oriented such that it monitors the vibrating asset which is the subject of the monitoring while the other vibrometer 506 is used to measure a fixed object 510 that is not moving. The fixed object 510 could be a frame or base near the asset. The measurement of the fixed object 510 will only include the vibration of the drone vibrometer whereas the measurement of the target 510 on the vibrating asset 504 will include both the vibration of the drone and the asset. Therefore, the difference between the two measurements is the vibration of the asset alone. Various embodiments disclosed herein can determine the difference between the two vibrations to accurately determine the vibration of the asset, which is then used to determine a health of the asset, that may be used to diagnosis problems and/or indicate repairs that are or will be needed. After the asset vibration is determined, a health of the machine may be determined by know methods such as disclosed in The Vibration Analysis Handbook by James Taylor, 1994.

The vibrometers 506, 508 may be rigidly attached to the gimble such that both vibrometers 506, 508 are exposed to approximately the same vibration resulting from the drone induced vibration. Slight adjustments to the orientation of the vibrometers 506, 508 may be needed for different measurement locations because the relative location of the fixed target to the asset target are not the same for every measurement of an asset target along a route where a plurality of assets are being measured. The slight difference in the orientation of the two vibrometers 506, 508 relative to one another introduces inaccuracy if the signal were directly differenced to come up with the asset vibration. The inaccuracy can be compensated by dividing the reference signal by the cosine of the difference of the reference and asset beam angles relative to vectors normal to the target surfaces.

However, in various embodiments herein the fixed and asset targets may be oriented substantially parallel to one another and substantially on the same plane. This greatly simplifies the compensation required to account for the slight difference in orientation of the two vibrometers. The fixed target may typically be mounted on a rigid surface like the base of the asset or bolted to the rigid structural frame of the asset.

Both measurements can be recorded simultaneously and then a difference between the measurements can be determined either in real-time or post recording. Generally this is performed in the time domain. Alternatively, the signal can be measured asynchronously, in which case a frequency spectrum difference may be utilized.

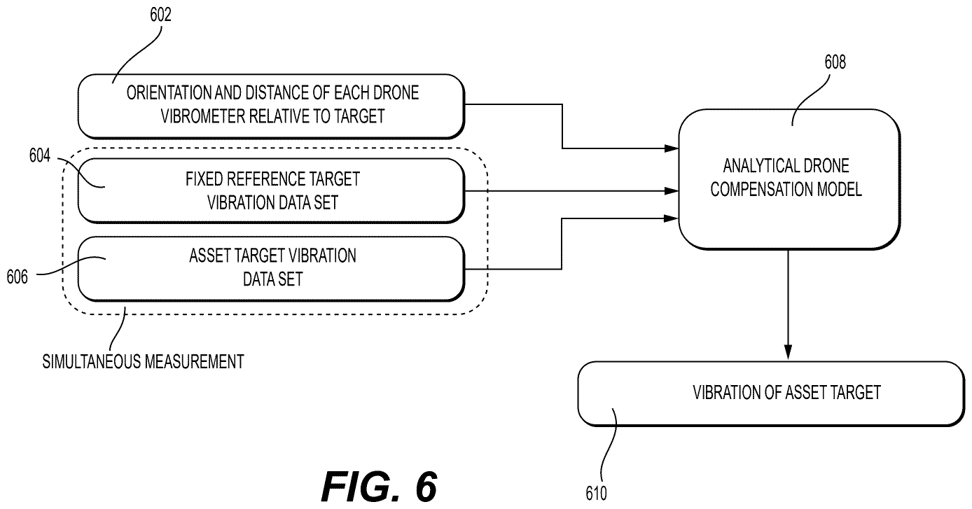

FIG. 6 illustrates steps taken by the systems and methods disclosed herein to determine machine or asset health. In 602, the drone 502 orients the laser vibrometers 506, 508 to direct the beams from the vibrometers 506 and 508 at the fixed reference target 510 and at the asset target 512. In steps 604 and 606, the systems and methods determine distances between each laser vibrometer and the targets 510, 512 which are used to calculate a vibration of the asset 502. In various embodiments, the vibration of the drone is compensated for in determining the vibration of the asset by subtracting the drone vibration determined from the fixed reference target measurement from the vibration determined from the asset target measurement. Techniques for determining vibration of an object from laser vibrometer measurements are known in the art. However, the embodiments herein utilize novel methods of utilizing one or more vibrometers and an accelerometer and gyroscope in other embodiments mounted on a drone to take the measurement and to determine vibration of the asset while compensating for the vibration of the drone to determine accurate vibration of the assets.

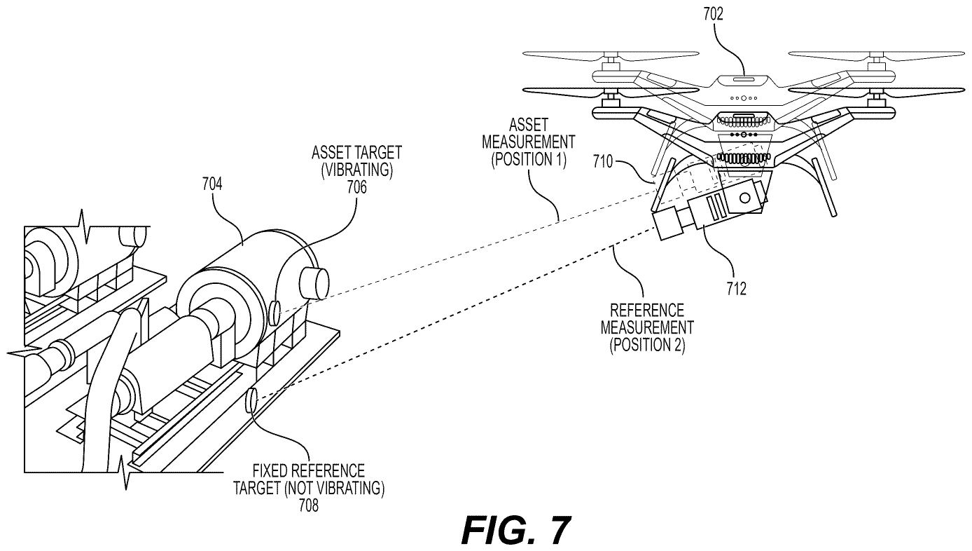

FIG. 7 shows a drone 702 taking two separate readings of the two targets, one on the vibrating asset 704 measured at the asset target 706 and one on a fixed object like the frame or base structure measured at the reference target 706. The drone 702 may be configured to move from one location to the next taking the readings asynchronously. The two time-series data sets can't be differenced directly to get the asset true vibration because they are taken at different times and the phases don't align. However, the frequency spectrum can be differenced directly which accurately produces the frequency spectrum for the asset alone. To perform this operation, embodiments disclosed herein utilize an FFT (Fast Fourier Transform) or other frequency spectrum conversion to transform the time series of each data set into frequency spectrums which are then differenced.

While the time series data is useful in some cases, the main data set that is used for diagnostics in accordance with various embodiments is the frequency spectrum, which makes this approach acceptable. Embodiments disclosed herein are configured to take the measurements with the drone vibrometer orientation, and distance to the asset targets and reference targets roughly equal and the absolute orientation of the targets is also parallel to one another. More complicated compensation techniques could be used in accordance with various embodiments if one of these requirements are not maintained.

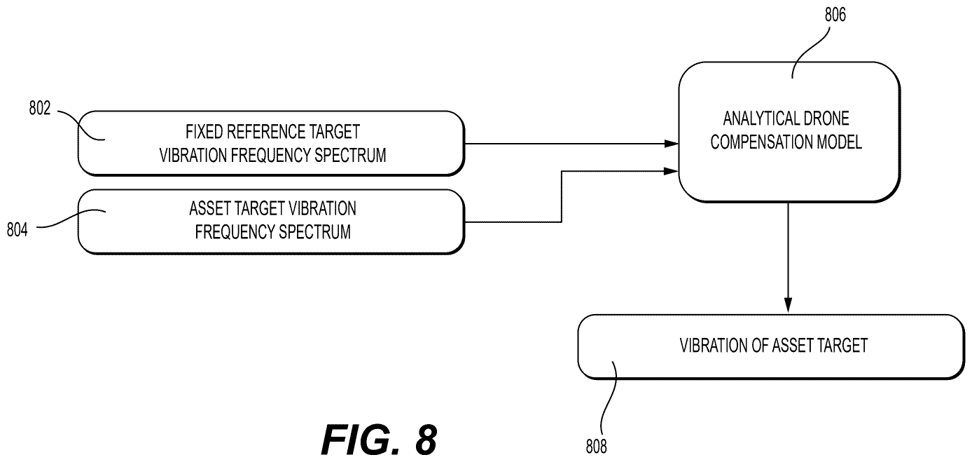

FIG. 8 illustrates steps taken by the systems and methods as described in conjunction with FIG. 7 and disclosed herein to determine machine or asset health in accordance with various embodiments. The drone 702 is configured to orient the laser vibrometers 710, 712 to direct the beams from the vibrometers 710 and 712 at the fixed reference target 708 and at the asset target 710. As described in conjunction with FIG. 7, the drone may take the measurements asynchronously and at different locations. In steps 802 and 804, the systems and methods determine distances between each laser vibrometer and the targets 810, 812 which are used to in 808 to calculate a vibration of the asset 802. In various embodiments, in 802 and 804, the measurements taken at the reference target and at the asset target may be converted to the frequency spectrum utilizing an FFT (Fast Fourier Transform) or other frequency spectrum conversion to transform the time series of each data set. In various embodiments, the vibration of the drone is compensated for in 806 by subtracting the drone vibration determined from the fixed reference target measurement from the vibration determined from the asset target measurement to generate the asset vibration in 808.

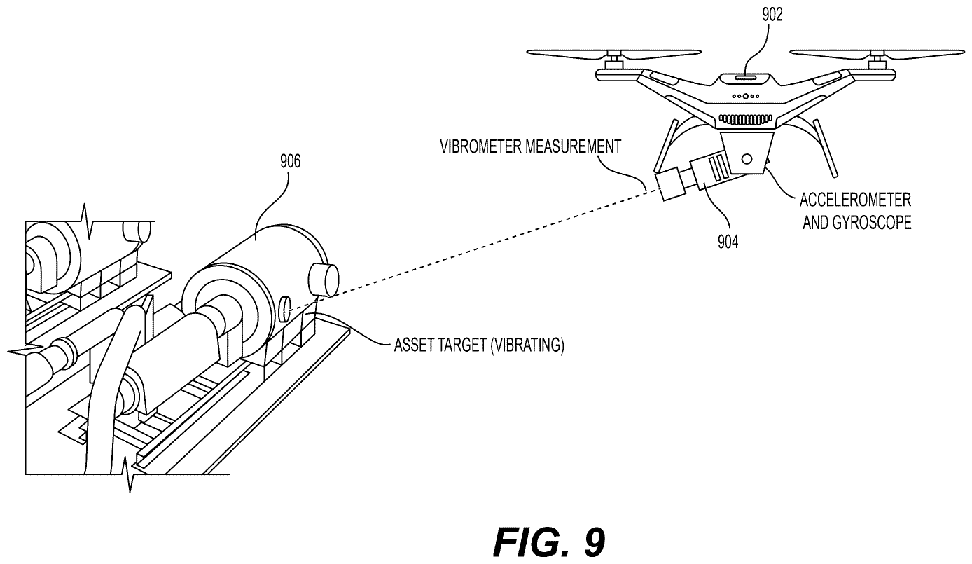

FIG. 9 shows a slightly different way of determining the asset vibration according to various embodiments. In these embodiments, a triaxial accelerometer and gyroscope may be rigidly affixed to the vibrometer 904 of the drone 902. These sensors are used to track the movement of the vibrometer 904 when it is taking a laser vibrometer reading of an asset 906. The measurement of the vibrometer movement is monitored synchronously with the laser vibrometer measurement. Typically, the vibrometer reading is triggered synchronously with the accelerometer and gyroscope measurement so that they are sampled at the same time. Alternatively, the data sets could be in alignment and the data resampled so long as the data is precision time stamped relative to a shared clock.

Both high fidelity data sets (laser vibrometer and six axis accel/gyro) along with the precise location of the drone at the time of the data collection is stored as a group of data. This group of data could also wirelessly be transferred to a gateway device during flight. Algorithms to compute the error and correct the vibrometer reading could also be done on the drone prior to transferring off the drone or putting the data in storage on the drone. In this case, the raw data could be discarded and only the corrected reading retained and/or transferred to the gateway.

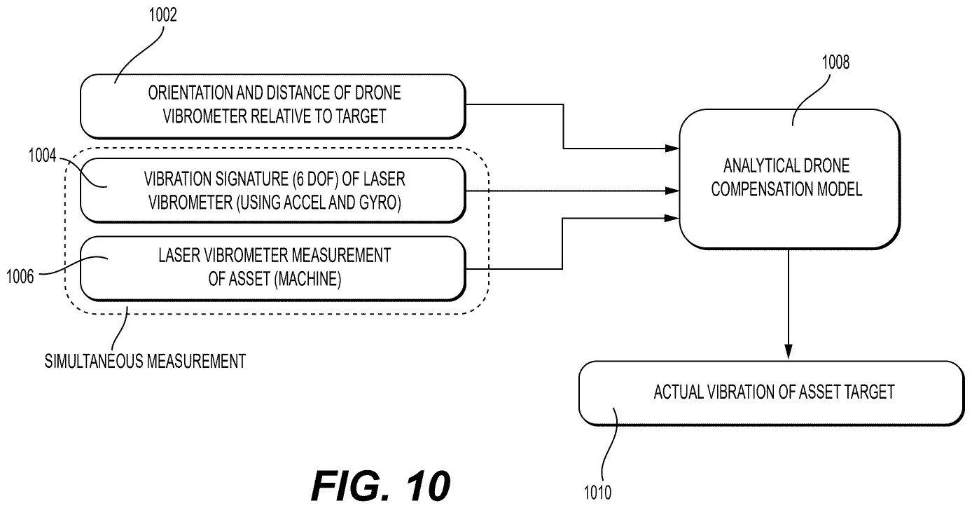

A simplistic representation of the input and output of the error correction algorithm for this approach is shown in FIG. 10. First, in 1002, the location and orientation of the drone vibrometer relative to the target are gathered. Next, in 1006, the vibration of the laser vibrometer taken while it is measuring the target is combined with the location and orientation data to generate an estimate of a dynamic error compensation. For example, the error compensation is a high frequency data set that matches the sampling frequency and duration of data collected by the laser vibrometer. Finally, in 1008, the error compensation is subtracted from the laser vibrometer data set obtained in 1004 using the analytical drone compensation model. This compensation is typically to be done in the time-domain but a frequency domain analysis could also be completed using a similar approach. The resulting data set obtained in 1010 is the actual vibration of the target and excludes the vibration of the drone.

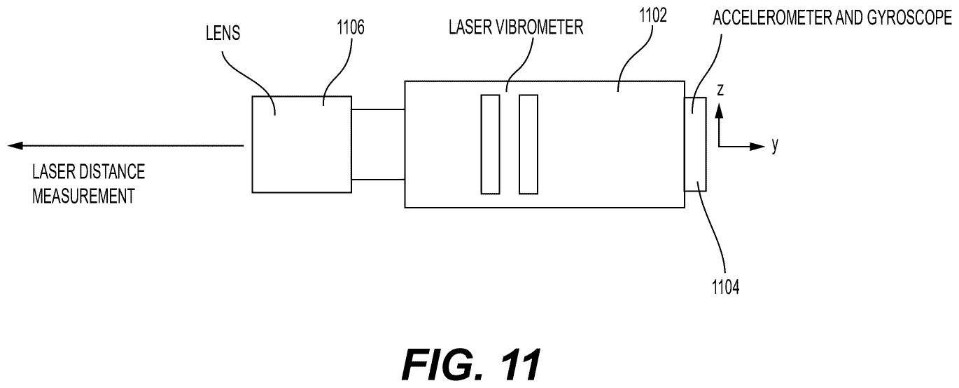

FIG. 11 illustrates the laser vibrometer 1102 that may be used in some embodiments, the laser vibrometer 1102 may include the accelerometer and gyroscope 1104 and the lens 1106.

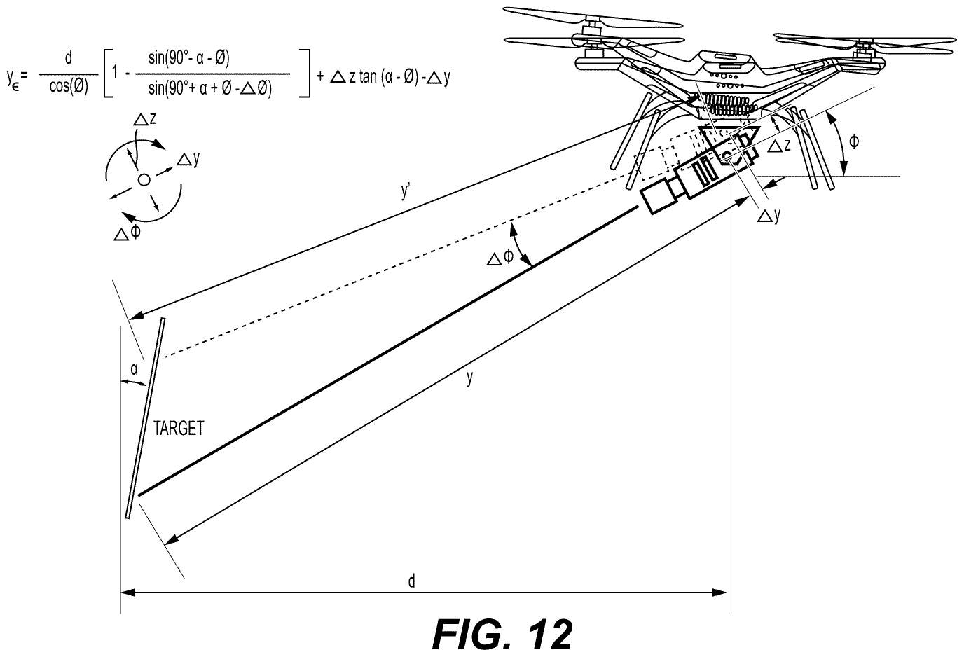

FIG. 12 shows a mathematical representation of how the error due to movement of the laser vibrometer may be calculated in accordance with various embodiments. The variable y_{∈} is the error in the measurement due to the movement of the drone along the axis of the laser beam. The parameter d is the horizontal distance to the target which is known based on the GPS or other RTLS location of the drone and the target. The parameter φ is the angle of the camera relative to a horizontal plane. This inclination is measured based on the mean or DC values of the accelerometer attached to the vibrometer (assuming it is using a MEMs accelerometer). The mathematical representation considers tilt of the target at an angle of α relative to a vertical plane. This tilt is common for assets that don't have a perfectly vertical surface to mount the target. It is a fixed parameter associated with the permanently attached target. However, vibration of the drone will change the orientation of the laser by Δφ which is considered in the error calculation. Finally, movement in the direction perpendicular to the beam direction is considered in Δz. The variables Δy, Δz, and Δφ may be directly measured by the accelerometer and gyroscopes mounted to the vibrometer.

Smaller values of d, φ, and α lead to smaller error even if the drone vibration level is the same. The closer the drone is to the target and the better aligned it is, the lower the error compensation required. Since there will be some error in the measurement of the dynamic motion of the vibrometer, this observation is important in some cases.

This two-dimensional error calculation is easily extended to three dimensions using a similar logic, but the equations and sketches to represent them become complicated and are therefore not shown in the figures.

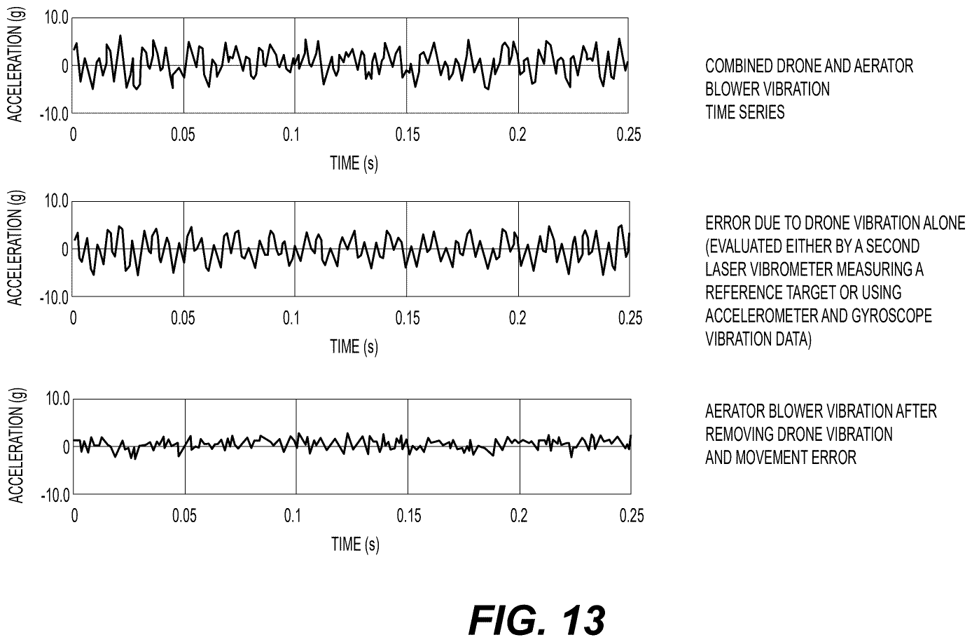

FIG. 13 shows an example of time series vibration signals for a drone laser vibrometer measuring an aerator in a cement manufacturing plant. The upper plot shows the raw time series of the vibrometer which includes both the drone and the asset vibration. This reading doesn't include any error compensation. The middle plot shows the drone vibration along the axis of the laser. This data set is either generated by measuring a fixed target (FIG. 6) or measuring the absolute vibration of the vibrometer using an accelerometer and gyroscope (FIG. 8). The lower plot shows the vibration of the aerator after the drone vibration error has been removed. Notice that in this case, the error due to the drone vibration is larger than the vibration of the aerator. And, if the drone vibration is not removed, the vibration signature recorded could lead to a false diagnosis.

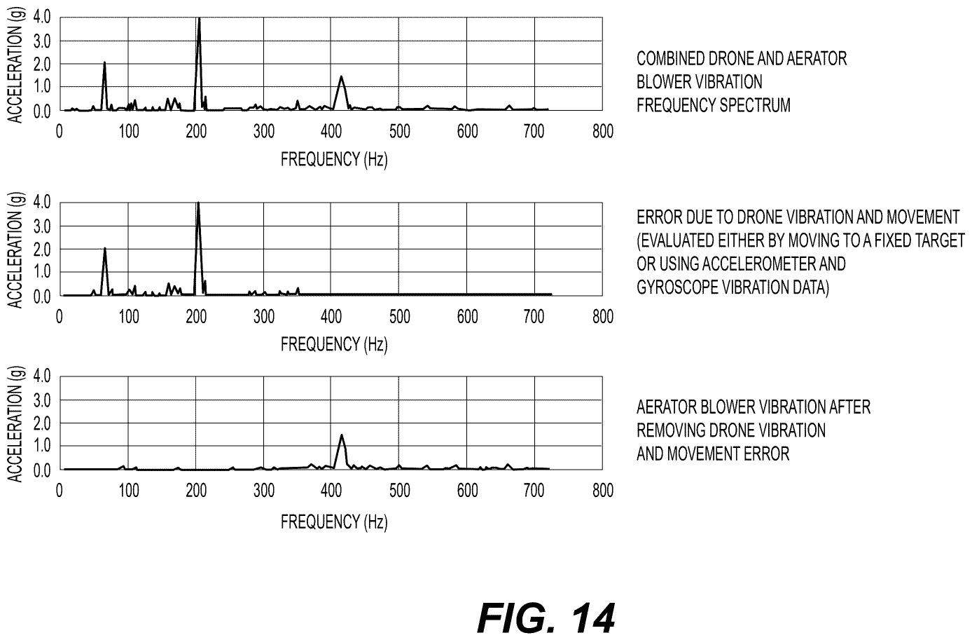

FIG. 14 shows the frequency spectrum of the combined drone and asset, drone alone, and asset alone. This frequency spectrum differencing approach (in contrast to the time series difference approach in FIG. 13) is most relevant for embodiments shown in FIG. 7, but could also be used in the embodiments shown in FIG. 5 and FIG. 9.

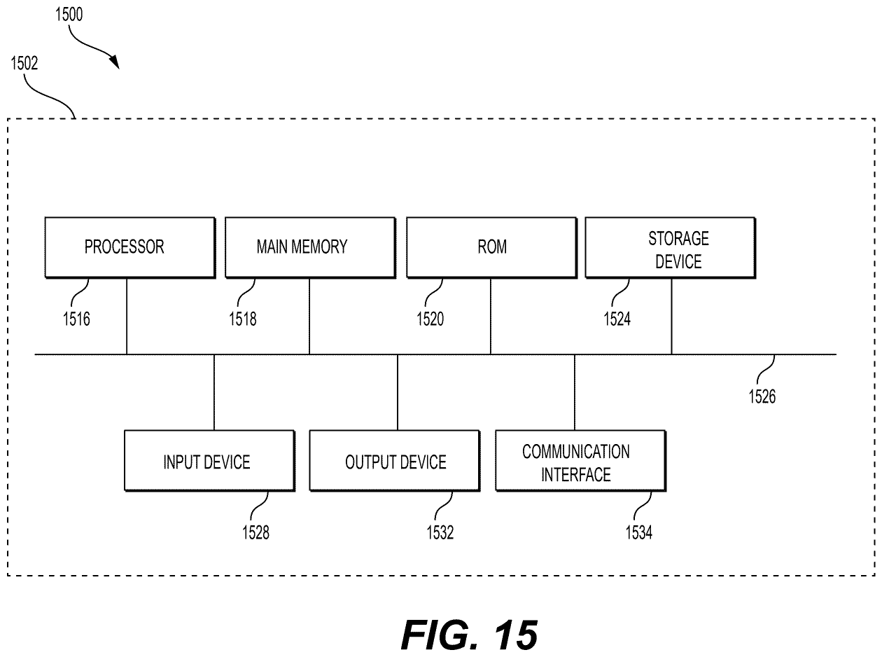

FIG. 15 shows a system block diagram illustrating an example of further details of a computing system, illustrated as computing system 1500, in accordance with aspects of the present disclosure. As shown in this example, the computing system 1500 may include a computing device 1510 capable of communicating via a network, such as the Internet. In example embodiments, the computing device 1510 may correspond to a mobile communications device (e.g., a smart phone or a personal digital assistant (PDA)), a portable computer device (e.g., a laptop or a tablet computer), a desktop computing device, a server, etc. In some embodiments, the computing device 1510 may host programming and/or an application to carry out the functions as described herein. The computing device 1510 is configured to receive and/or obtain the datasets over communications interface 1534, for example.

The computing device 1510 may include a bus 1514, a processor 1516, a main memory 1518, a read only memory (ROM) 1520, a storage device 1524, an input device 1528, an output device 1532, and a communication interface 1534. Bus 1514 may include a path that permits communication among the components of device 1510. Processor 1516 may be or include a processor, a microprocessor, an application specific integrated circuit (ASIC), a field programmable gate array (FPGA), or another type of processor that interprets and executes instructions. Main memory 1518 may include a random access memory (RAM) or another type of dynamic storage device that stores information or instructions for execution by processor 1516. ROM 1520 may include a ROM device or another type of static storage device that stores static information or instructions for use by processor 1516. Storage device 1524 may include a magnetic storage medium, such as a hard disk drive, or a removable memory, such as a flash memory.

Input device 1528 may include a component that permits an operator to input information to device 1510, such as a control button, a keyboard, a keypad, or another type of input device. Output device 1532 may include a component that outputs information to the operator, such as a light emitting diode (LED), a display, or another type of output device. Communication interface 1534 may include any transceiver-like component that enables device 1510 to communicate with other devices or networks. In some implementations, communication interface 1534 may include a wireless interface, a wired interface, or a combination of a wireless interface and a wired interface. In embodiments, communication interface 1534 may receive computer readable program instructions from a network and may forward the computer readable program instructions for storage in a computer readable storage medium (e.g., storage device 1524).

System 1500 may perform certain operations, as described in detail herein. System 1500 may perform these operations in response to processor 1516 executing software instructions contained in a computer-readable medium, such as main memory 1518. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 1518 from another computer-readable medium, such as storage device 1524, or from another device via communication interface 1534. The software instructions contained in main memory 1518 may direct processor 1516 to perform processes that will be described in greater detail herein. Alternatively, hardwired circuitry may be used in place of or in combination with software instructions to implement processes described herein. Thus, implementations described herein are not limited to any specific combination of hardware circuitry and software.

The system 1500 may be connected to a communications network (not shown), which may include one or more wired and/or wireless networks. For example, the network may include a cellular network (e.g., a second generation (2G) network, a third generation (3G) network, a fourth generation (4G) network, a fifth generation (2G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the communications network may include copper transmission cables, optical transmission fibers, wireless transmission, routers, firewalls, switches, gateway computers and/or edge servers.

The computing device 1510 shown in FIG. 15 may be configured to monitor a health condition of a machine with a drone having a laser vibrometer device. The computing device 1510 may be configured to receive signals generated by the drone based on the vibration measurements of the machine, the signals being representative of: 1) a vibration of the drone; and 2) a vibration of the machine plus a vibration of the drone. The computing device 1510 may be configured to determine a vibration of the machine by compensating the vibration of the machine plus the vibration of the drone with the vibration of the drone. The vibration of the machine may be used by the computing device 1510 to determine a health condition of the machine.

One of ordinary skill will recognize that the components, arrangement, and implementation details of the computing system 1510 are examples presented for conciseness and clarity of explanation. Other components, implementation details, and variations may be used, including adding, combining, or subtracting components and functions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer readable program instructions also may be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). The software and/or algorithms described above and illustrated in the flowcharts may be modified in any manner that accomplishes the functions described herein. In addition, the functions in the flowcharts or description may be performed in any order that accomplishes a desired operation.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

1. A system for monitoring a health condition of a machine, comprising:
a drone;
a laser vibrometer device mounted on the drone, the laser vibrometer device being configured to take vibration measurements of the machine from an aerial position; and
a computerized device configured to receive signals based on the vibration measurements of the machine, the signals being representative of: 1) a vibration of the drone; and 2) a vibration of the machine plus a vibration of the drone, wherein the computerized device is configured to determine a vibration of the machine by compensating the vibration of the machine plus the vibration of the drone with the vibration of the drone, and wherein the vibration of the machine is used by the computerized device to determine a health condition of the machine.

2. The system of claim 1, wherein the laser vibrometer device is configured to take measurements of a machine target on the machine and to take measurements of a target on a fixed object near the machine.

3. The system of claim 2, wherein the laser vibrometer device comprises a first laser vibrometer and a second laser vibrometer, wherein the first laser vibrometer is configured to take vibration measurements of the machine target and the second laser vibrometer is configured to take measurements of the target on the fixed object.

4. The system of claim 2, wherein the laser vibrometer device is configured to take vibration measurements of the machine target from a first aerial position of the drone and to take vibration measurements of the target on the fixed object from a second aerial position of the drone different from the first aerial position.

5. The system of claim 1, further comprising an accelerometer and a gyroscope mounted on the vibrometer, wherein the accelerometer and the gyroscope are configured to measure a vibration of the drone.

6. A method of monitoring a health condition of a machine with a drone having a laser vibromenter device, comprising:
receiving at a hardware processor measurements of the machine measured by the laser vibrometer of the drone;
determining a vibration of the machine at the hardware processor based on the vibration measurements, wherein the vibration measurements are representative of: 1) a vibration of the drone; and 2) a vibration of the machine plus a vibration of the drone, and wherein the processor is configured to determine the vibration of the machine by compensating the vibration of the machine plus the vibration of the drone with the vibration of the drone; and
determining the health condition of the machine based on the determined vibration of the machine.

7. The method of claim 6, wherein the laser vibrometer device is configured to take measurements of a machine target on the machine and to take measurements of a target on a fixed object near the machine.

8. The method of claim 7, wherein the laser vibrometer device comprises a first laser vibrometer and a second laser vibrometer, wherein the first laser vibrometer is configured to take vibration measurements of the machine target and the second laser vibrometer is configured to take measurements of the target on the fixed object.

9. The method of claim 7, wherein the laser vibrometer device is configured to take vibration measurements of the machine target from a first aerial position of the drone and to take vibration measurements of the target on the fixed object from a second aerial position of the drone different from the first aerial position.

10. The method of claim 6, wherein the drone includes an accelerometer and a gyroscope mounted on the vibrometer, wherein the accelerometer and the gyroscope are configured to measure a vibration of the drone.

11. A non-transitory computer-readable medium storing instructions which, when executed by one or more processors of a system, cause the system to monitor a health condition of a machine with a drone having a laser vibrometer by performing operations comprising:
receiving at a hardware processor vibration measurements of the machine measured by the laser vibrometer of the drone from an aerial position;
determining a vibration of the machine at the hardware processor based on the vibration measurements, wherein the vibration measurements are representative of: 1) a vibration of the drone; and 2) a vibration of the machine plus a vibration of the drone, and wherein the processor is configured to determine the vibration of the machine by compensating the vibration of the machine plus the vibration of the drone with the vibration of the drone; and
determining the health condition of the machine based on the determined vibration of the machine.

12. The non-transitory computer-readable medium of claim 11, wherein the laser vibrometer device is configured to take measurements of a machine target on the machine and to take measurements of a target on a fixed object near the machine.

13. The non-transitory computer-readable medium of claim 12, wherein the laser vibrometer device comprises a first laser vibrometer and a second laser vibrometer, wherein the first laser vibrometer is configured to take vibration measurements of the machine target and the second laser vibrometer is configured to take measurements of the target on the fixed object.

14. The non-transitory computer-readable medium of claim 12, wherein the laser vibrometer device is configured to take vibration measurements of the machine target from a first aerial position of the drone and to take vibration measurements of the target on the fixed object from a second aerial position of the drone different from the first aerial position.

15. The non-transitory computer-readable medium of claim 11, wherein the drone includes an accelerometer and a gyroscope mounted on the vibrometer, wherein the accelerometer and the gyroscope are configured to measure a vibration of the drone.

16. A device for monitoring a health condition of a machine based on measurements from a laser vibrometer mounted on a drone, comprising:
a memory configured to store instructions; and
a hardware processor configured to receive the measurements of the machine measured by the laser vibrometer of the drone from an aerial position, to determine a vibration of the machine based on the vibration measurements, wherein the vibration measurements are representative of: 1) a vibration of the drone; and 2) a vibration of the machine plus a vibration of the drone, and wherein the hardware processor is configured to determine the vibration of the machine by compensating the vibration of the machine plus the vibration of the drone with the vibration of the drone, and to determine the health condition of the machine based on the determined vibration of the machine.

17. The device of claim 16, wherein the laser vibrometer device is configured to take measurements of a machine target on the machine and to take measurements of a target on a fixed object near the machine.

18. The device of claim 17, wherein the laser vibrometer device comprises a first laser vibrometer and a second laser vibrometer, wherein the first laser vibrometer is configured to take vibration measurements of the machine target and the second laser vibrometer is configured to take measurements of the target on the fixed object.

19. The device of claim 17, wherein the laser vibrometer device is configured to take vibration measurements of the machine target from a first aerial position of the drone and to take vibration measurements of the target on the fixed object from a second aerial position of the drone different from the first aerial position.

20. The device of claim 16, wherein the drone includes an accelerometer and a gyroscope mounted on the vibrometer, wherein the accelerometer and the gyroscope are configured to measure a vibration of the drone.
